(19) United States
(12) Patent Application Publication
(10) Pub. No.: US 2010/0036687 A1
(43) Pub. Date: Feb. 11, 2010

(54) MOBILE TRANSPORT SELECTION AND ACQUISITION

(75) Inventors: Ravi P. Bansal, Tampa, FL (US); Brian M. O'Connell, Cary, NC (US); James W Seaman, Falls Church, VA (US); Keith R. Walker, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: INTERNATIONAL BUISNESS MACHINES CORPORATION, Armonk, NY (US)

(21) Appl. No.: 12/186,279

(22) Filed: Aug. 5, 2008

(51) Int. Cl. G06Q 10/00

(52) U.S. Cl. 705/5

(57) ABSTRACT

A method, system, and computer program product for improving transportation selection and acquisition. A computer transmits historical fare and rating data of one or more public transportation vehicles (PTVs) within range of a user operating a mobile telecommunication device (MTD). The user may, via the MTD, select a PTV based on the provided historical fare or ratings data. Alternatively, the user may select a PTV based on personal preferences. In response to receiving a PTV selection from the MTD, the computer issues instructions to cause the selected PTV to be dispatched to the user's location. The computer may also receive user feedback for the selected PTV from the user in the form of a rating or as a textual comment. Customer feedback and may be used to update historical record information of a corresponding database entry for the selected PTV. This information may then be referenced by future customers.

### BACKGROUND OF THE INVENTION

1. Technical Field

The present invention relates in general to public transportation systems, and in particular to public transportation computer systems. Still more particularly, the present invention relates a system for transmitting fare and transportation information of public transportation vehicles (PTVs) within range of a user operating a mobile telecommunication device (MTD).

2. Description of the Related Art

Taxi cabs and other public transportation vehicles are a popular means of transportation throughout the world. Traditionally, public transportation vehicles (PTVs) are requested or hailed while they are in transit on streets or at stations. Such stations may be formally provided by the municipality, and/or may be located near prominent locations. Alternatively, a customer may call a dispatching service operated independently or by the public transportation company. When a customer calls a dispatcher, the dispatcher may contact the operator of one or more PTVs near the customers location to determine which PTVs are available to pick up the customer. The operator may then notify the customer of availability.

### SUMMARY OF THE INVENTION

Disclosed are a method, system, and computer program product for improving transportation selection and acquisition. Logic of a computer transmits historical fare and rating data of one or more public transportation vehicles (PTVs) within range of a user operating a mobile telecommunication device (MTD). Upon receiving this information, the user may, via the MTD, select a PTV based on the provided historical fare or ratings data. Alternatively, the user may select a PTV based on personal preferences. In response to receiving a PTV selection from the MTD, the computer issues instructions to cause the selected PTV to be dispatched to the user's location. The computer may also receive user feedback for the selected PTV from the user in the form of a rating or as a textual comment. Customer provided feedback and fare information of the transportation route may be used to update historical record information and user feedback ratings of a corresponding database entry for the selected PTV. This information may then be referenced by future patrons of the selected PTV.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, will best be understood by reference to the following detailed descriptions of an illustrative embodiment when read in conjunction with the accompanying drawings, wherein:

FIG. 1 is a block diagram of a computer in which the present invention may be implemented; and

FIG. 2 is a block diagram of an exemplary system for improving transportation selection and acquisition.

FIG. 3 is a diagram of an exemplary user interface of a public transportation vehicle selection list for improving transportation selection and acquisition.

FIG. 4 is a diagram of an exemplary user interface of a feedback request for improving transportation selection and acquisition.

FIG. 5 is a high-level logical flowchart of an exemplary method for improving transportation selection and acquisition, according to one embodiment.

### DETAILED DESCRIPTION OF THE PREFERRED EMBODIMENT

The illustrative embodiments provide a method, system, and computer program product for improving transportation selection and acquisition, in accordance with one embodiment of the invention.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

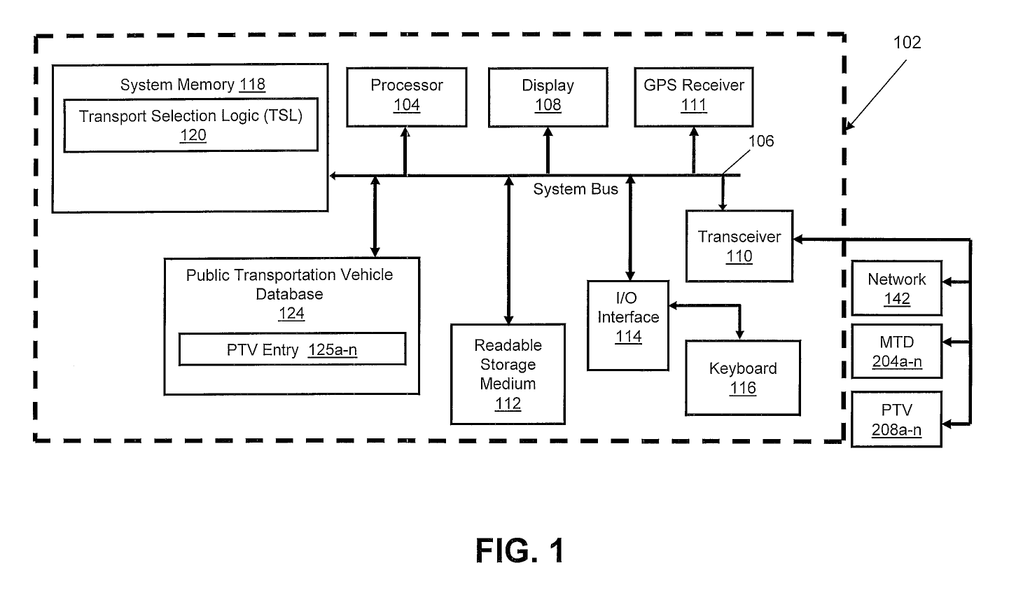

With reference now to FIG. 1, there is depicted a block diagram of a computer 102 in which the present invention may be implemented. Computer 102 includes a processor 104 that is coupled to a system bus 106. In an alternate embodiment, processor 104 may be a database engine. A transceiver 110, connected to system bus 106, enables computer 102 to connect to network 142, Mobile Telecommunication Devices MTDs 204a-n, and Public Transportation Vehicles PTVs 208a-n, via wired or wireless mechanisms. A Global Positioning Satellite (GPS) Receiver 111, connected to system bus 106, enables computer 102 to received global positioning satellite (GPS) data or cellular-triangulation data to identify the location of MTDs 204a-n, or PTVs 208a-n in real-time. Display 108, coupled to system bus 106, allows for presentation of a general user interface (including text and graphics) for use by a user of computer 102. System bus 106 also affords communication with a hardware-based readable storage medium 112 (e.g., Compact Disk-Read Only Memory (CD-ROM), flash drive memory, etc). Input/Output (I/O) Interface 114, also connected to system bus 106, permits user interaction with computer 102, such as data entry via keyboard 116.

Computer 102 also comprises a public transportation vehicle database 124, which is connected to system bus 106. Public transportation vehicle database 124 comprises one or more public transportation vehicle (PTV) entries 125a-n. A PTV entry 125a-n comprises historical data gathered for a specific PTV 208a-n. When computer 102 receives additional data about a specific PTV 208a-n, that data are updated within the corresponding PTV entry 125a-n.

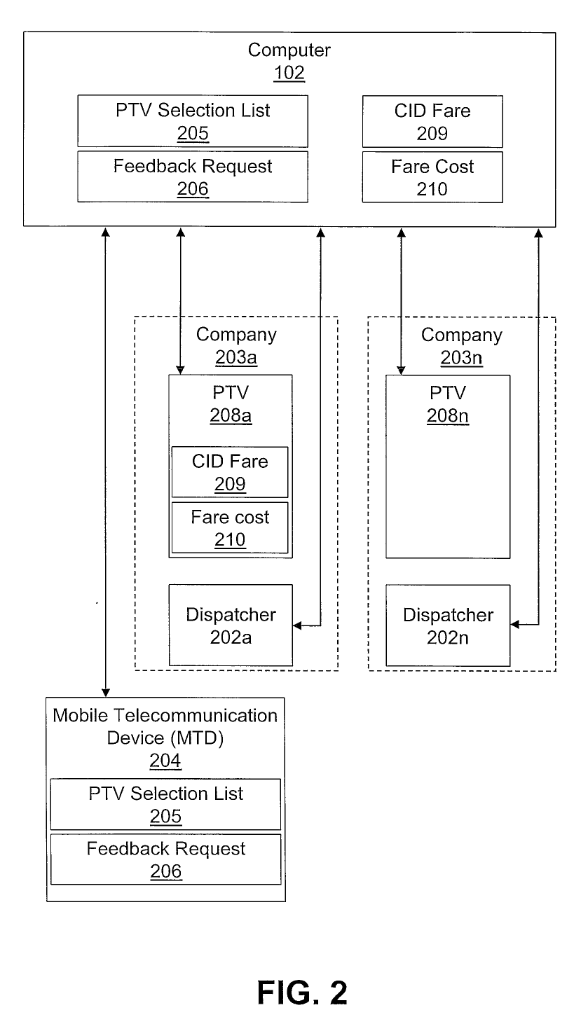

Computer 102 also comprises system memory 118, which is connected to system bus 106. As shown, system memory 118 also comprises transport selection logic (TSL) 120 for improving mobile transportation selection and acquisition. TSL 120 includes code for implementing the processes described in FIGS. 2-5. In one embodiment, computer 102 is able to utilize TSL 120 to transmit, to a user MTD, fare and transportation information of PTVs 208a-n that are within range of a user operating a mobile telecommunication device (MTD) 204. In response to receiving a PTV selection from the MTD, TSL 120 may autonomously transmit a signal to the selected PTV to dispatch the selected PTV to the user's location, as described in greater detail below in FIGS. 2-5.

As illustrated and described herein, computer 102 may be a computer system or server having the required hardware components and programmed with TSL 120, executing on the processor to provide the functionality of the invention. However, computer 102 may also be a device that is specifically designed to include the functionality of TSL 120, as described herein. The hardware elements depicted in computer 102 are not intended to be exhaustive, but rather are representative to highlight essential components required by and/or utilized to implement the present invention. For instance, computer 102 may include alternate memory storage devices such as magnetic cassettes, Digital Versatile Disks (DVDs), Bernoulli cartridges, and the like. These alternate configurations of components and other variations are intended to be within the spirit and scope of the present invention.

With reference now to FIG. 2, there is illustrated an exemplary system for improving mobile transportation selection and acquisition, in accordance with one embodiment of the invention. The illustrative embodiment is described from the perspective of the computer receiving a request from a Mobile Telecommunication Device (MTD) 204 (e.g., a Personal Assistant Device (PDA) or a cell phone) containing a starting location and a desired destination that the user of MTD 204 wishes to travel to. Upon receiving this initial request, logic of the computer (e.g., TSL 120), executed by a CPU/processor to perform/enable a series of functions, determines one or more public transportation vehicles (PTVs) 208a-n within a closest proximity of the starting location specified by MTD 204. Other logic components may perform one or more of the processes; collectively referred to herein as logic. The closest proximity is a predetermined physical distance established by the logic. Logic may determine the proximity of PTVs 208a-n to the starting location by utilizing a GPS receiver (e.g., GPS Receiver 111) capable of receiving real-time location of PTVs 208a-n and MTD 204, or by using a last known location of MTD 204 and/or PTVs 208a-n. MTD 204 and PTVs 208a-n may be similarly equipped with a GPS technology for transmitting a real-time location.

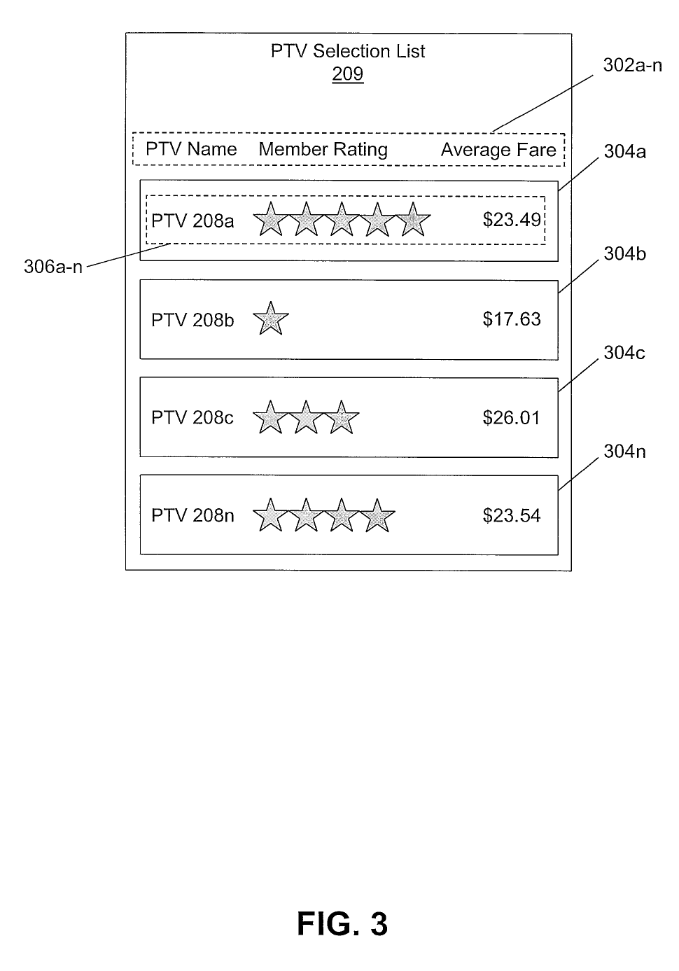

After determining which PTVs 208a-n are within proximate range of MTD 204, logic transmits a PTV Selection List 205 specifying proximate PTVs 208a-n to MTD 204. PTV Selection List 205 is a list of PTVs 208a-n identified by logic as being within a proximate range of the starting location. Upon receiving PTV Selection List 205, a user of MTD 204 may select a PTV 208a-n, as shown in greater detail in FIG. 3. Upon receiving the user selection, logic transmits a Customer Identification Fare (CID Fare) 209 to the selected PTV 208a-n. CID Fare 209 contains the starting location and desired destination received from the MTD 204. CID Fare 209 may also contain relevant information about the user of MTD 204 (e.g., first name, last name), used to identify the user to the operator of the selected PTV 208a-n. After receiving CID Fare 209, the selected PTV 208a-n may inform the operator of the selected PTV 208a-n of CID Fare 209 and autonomously transmit a notification to computer 102, informing computer 102 that CID Fare 209 has been accepted and that the selected PTV 208a-n is in route to pick up the customer. After the confirmation has been received, computer 102 may autonomously transmit a notification message to MTD 204 informing the user that the PTV 208a-n has accepted CID Fare 209 and is in route to the starting location. The notification message may also contain an estimated time of arrival to the starting location. When logic determines that the operator of the selected PTV 208a-n has not confirmed the CID fare 209 within a previously-established maximum amount of time (e.g., 3 minutes), logic may autonomously initiate a voice call between the MTD 204 and a dispatcher 202a-n of a company 203a-n affiliated with the selected PTV 208a-n. Alternatively, computer 102 may provide contact information (e.g., phone number) of the company and/or operator of the selected PTV 208a-n. The maximum amount of time may be pre-programmed by a designer or programmer of computer 102, or may be specified by the user of MTD 204, and transmitted to computer 102. In one embodiment, when the configured maximum amount of time has expired, the user of MTD 204 may select an alternate PTV 208a-n from the PTV Selection List 205.

PTV Selection List 205 may also contain historical data for the PTVs 208a-n listed. In one embodiment, computer 102 may contain a historical database (e.g., Public Transportation Vehicle Database 124) containing records (e.g., PTV Entry 125a-n) of one or more PTVs 208a-n. Each record may contain historical rate/billing information as well as historical feedback data or ratings completed by past patrons of that PTVs 208. This information may be used to assist the user of PTV 204 in selecting an appropriate PTV 208a-n for their specific needs (e.g., lowest cost, cleanest cab, quickest ride, etc).

Computer 102 may additionally monitor for when the selected PTV 208a-n has arrived at the destination. In one embodiment, logic may monitor for when the transport is complete by determining when the selected PTV 208a-n and MTD 204 are no longer moving together or are moving in different directions. In an alternate embodiment, logic may monitor when the transport is complete by tracking the PTV 208a-n to the desired destination. These processes may be confirmed by a GPS receiver (e.g., GPS Receiver 111) or cellular-phone point triangulation technology utilized computer 102 to determine the location of MTD 204 and PTVs 208a-n. Similarly, PTVs 208a-n and MTD 204 may be configured with a GPS receiver and software autonomously determining and transmitting the current location in real-time to Computer 102. Computer 102 may receive a Fare Cost 210 upon the selected PTV 208a-n arriving at the destination. Fare Cost 210 is the total fare of the transportation billed to the customer. Fare Cost 210 may be autonomously transmitted to computer 102. When the operator of a PTV 208a-n bills a customer, the Fare Cost 210 may be transmitted to and archived into a corresponding historical record of computer 102 for that PTV 208a-n.

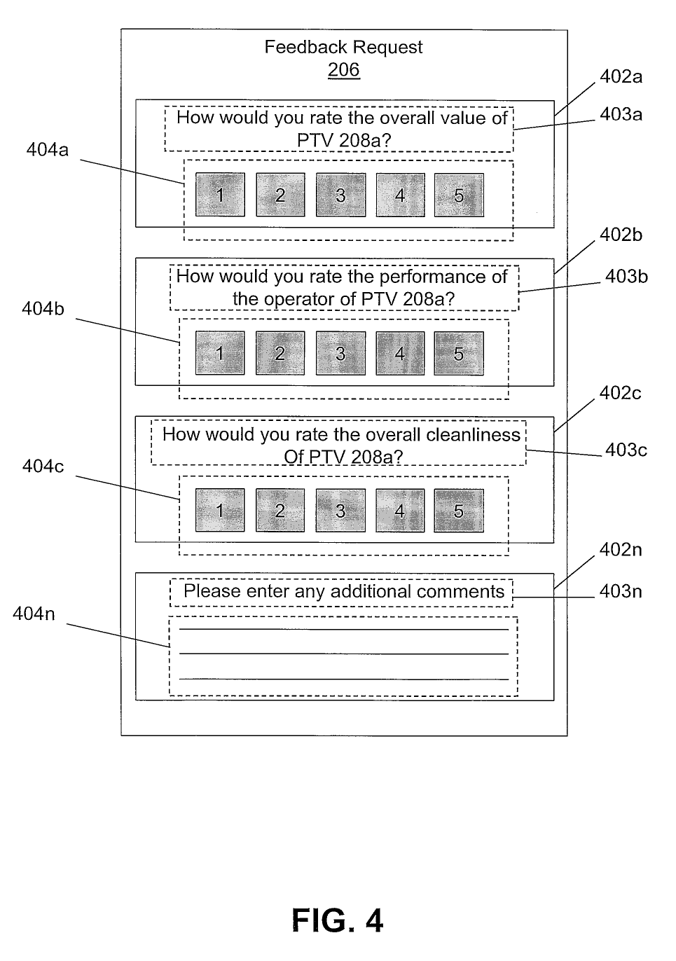

When logic determines that the PTV has arrived at the destination, computer 102 may autonomously transmit a feedback request 206 to MTD 204. Feedback request 206 is a notification message containing a series of question fields. Feedback request 206 may also incorporate a graphical user interface, as shown in greater detail in FIG. 4. Feedback request 206 may call for the user of the MTD to enter comments of their experiences on the selected PTV 208a-n. These comments may be given in the form of a textual response or by assigning a numerical rating in one or more categories. When logic determines that a response to feedback request 206 has not been received within a pre-established amount of time, computer 102 may autonomously transmit a second feedback request 206 to a secondary contact (e.g., an email address, an alternate phone, a personal computer) registered to the owner of the MTD 204. In an alternate embodiment, the secondary contact may be a physical mailing address of the user. When computer 102 receives a response to a feedback request 206, logic may update or add the received feedback data into an existing or a new historical record for the corresponding PTV 208a-n within computer 102. In an alternate embodiment, a user of MTD 204 may also initiate feedback of the selected PTV 208a-n at any time during transit.

With reference now to FIG. 3, there is illustrated a diagram of an exemplary graphical user interface of a public transportation vehicle selection list for improving mobile transportation selection and acquisition. PTV Selection List 209 may contain a selection of one or more PTVs 208a-n identified by logic as being within a pre-established configured proximate range of the starting location. PTV selection list may organize PTVs 208a-n by one or more categories 302a-n (e.g., PTV name, Member Rating, Average Fare). Each PTV Selection 304a-n listed may identify record information 306a-n (e.g., the name of the PTV selection 304a-n, a rating value for the PTV selection 304a-n, an average fare for the PTV selection 304a-n) corresponding to each category 302a-n. Record information 306a-n may be presented in a textual or graphical form.

With reference now to FIG. 4, there is provided a diagram of an exemplary user interface of a feedback request for improving mobile transportation selection and acquisition. Feedback request 206 may contain of one or more questions 402a-n. Each question 402a-n may contain a title 403a-n and a response area 404a-n. Title 403a-n defines the query to the user, and also asks the user to select or tender a response in the response area 404a-n. The response area 404a-n may contain an area for a user to enter a text-based response, or in an alternate embodiment, may contain two or more buttons for a user of the MTD to select an answer. It is important to note that questions 402a-n, titles 403a-n, and response areas 404a-n may be presented in a textual or graphical form.

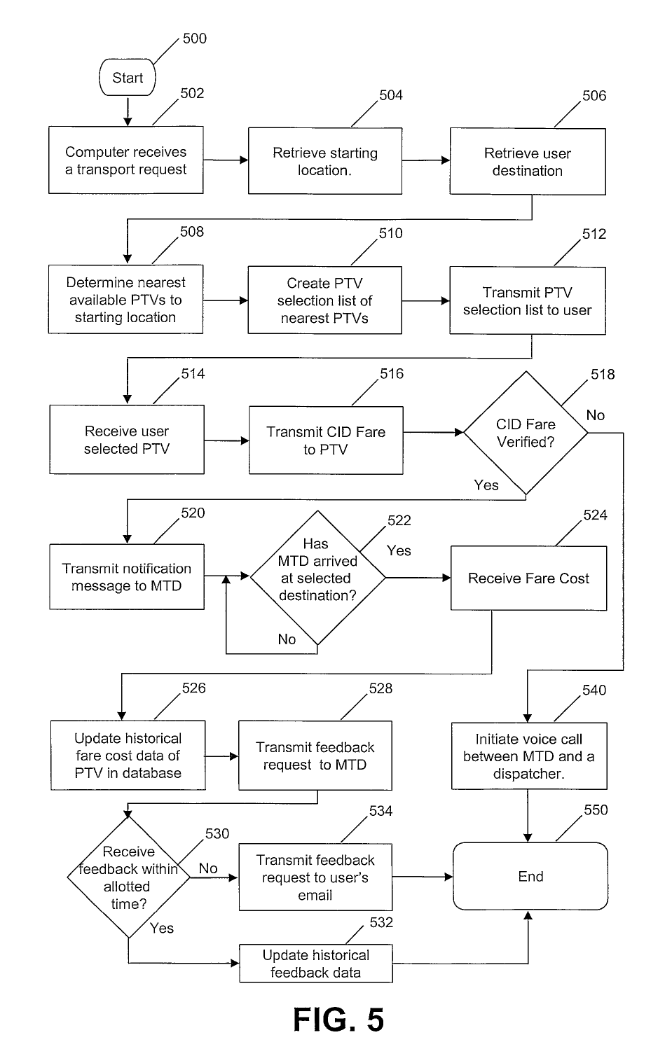

With reference now to FIG. 5, there is provided a high-level logical flowchart of an exemplary method for improving mobile transportation selection and acquisition. After initiator block 500, the computer receives a transport request containing a starting location and a destination from a MTD (block 502). Logic may then retrieve the starting location where the user of the MTD would like to be picked up (block 504). Logic may then also retrieve the destination where the user of the MTD would wishes to travel to (block 506). The computer may then utilize a GPS receiver to receive and real-time location of one or more PTVs nearest to the starting location specified by the MTD (block 508). The computer then creates a PTV selection list containing one or more PTVs within the close physical proximity to the starting location (block 510). Additionally, the PTV selection list may contain historical rate/billing information as well as historical feedback data or ratings completed by past patrons of one or more PTVs on the PTV selection list. Logic may then transmit the PTV selection list to the MTD (block 512). The user of the MTD may then make a selection of a PTV from the PTVs specified on the PTV selection list. The computer receives the user selection (block 514).

Upon receiving a user selected PTV, logic transmits a CID Fare to the selected PTV (block 516). CID Fare contains the starting location and desired destination of the user of MTD. The operator of the selected PTV may confirm that they accept the CID Fare, and agree to pick up the customer. The computer determines whether the verification is received within a pre-established time period (block 518). When the computer does not receive verification of the CID Fare, logic initiates a voice call between the MTD and a dispatcher of the company affiliated with the selected PTV (block 540). The process then ends at terminator block 550. When the computer receives verification that the CID fare has been accepted, logic may transmit a notification message to the MTD, informing the user that the fare has been accepted and that the selected PTV is en-route to the starting location (block 520).

Logic may monitor the progress of the transit from the starting location to the destination. Upon detecting that MTD has arrived at the destination (block 522), the computer may receive a fare cost of the transit from the PTV (block 524). Logic may then update the historical fare cost data of the PTVsaved in a database of the computer (block 526). Logic may transmit a feedback request to the MTD requesting the user of the MTD provide opinions of the transit (block 528). Logic then determines if a response to the feedback request was received within a pre-established amount of time (block 530). When the computer receives a response to the feedback request within the allotted amount of time, logic autonomously updates historical feedback data of the selected PTV stored within the database (block 532). The process may then complete at terminator block 550.

When the computer does not receive a response to the feedback request within the allotted amount of time, logic autonomously transmits a secondary feedback request to a secondary contact registered to the owner of the MTD (block 534). The process may then complete at terminator block 550.

In the flow charts above, one or more of the methods are embodied such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

Although aspects of the present invention have been described with respect to a computer processor and program application/logic, it should be understood that at least some aspects of the present invention may alternatively be implemented as a program product for use with a data storage system or computer system. Programs defining functions of the present invention can be delivered to a data storage system or computer system via a variety of signal-bearing media, which include, without limitation, non-writable storage media (e.g. CD-ROM), writable storage media (e.g. network attached storages, hard disk drive, read/write CD-ROM, optical media), and communication media, such as computer and telephone networks including Ethernet. It should be understood, therefore, that such signal-bearing media, when carrying or encoding computer readable instructions that direct method functions of the present invention, represent alternative embodiments of the present invention. Further, it is understood that the present invention may be implemented by a system having means in the form of hardware, software, or a combination of software and hardware as described herein or their equivalent.

Having thus described the invention of the present application in detail and by reference to illustrative embodiments thereof, it will be apparent that modifications and variations are possible without departing from the scope of the invention defined in the appended claims. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for improving mobile transportation selection and acquisition, the method comprising:
receiving a transportation request from a mobile telecommunication device (MTD), wherein the transportation request includes a starting location and a destination;
transmitting a public transportation vehicle (PTV) selection list to the MTD;
in response to receiving a PTV selection from the MTD, transmitting a customer identification (CID) fare to the selected PTV, wherein the CID fare contains the starting location and the destination location of a desired transportation request; and
receiving a fare confirmation from the selected PTV, wherein the fare confirmation confirms that an operator of the selected PTV has accepted the transportation request and is en-route to the starting location.

2. The method of claim 1, further comprising, in response to receiving the fare confirmation within a pre-established amount of time, transmitting a notification message to the MTD, wherein the notification message informs the user of the MTD that the selected PTV has confirmed the CID fare and is en-route to the starting location.

3. The method of claim 1, further comprising:
in response to not receiving the fare confirmation within the pre-established amount of time, establishing a phone call connection between the MTD and a dispatcher;
transmitting an instruction to the MTD to select a second PTV; and
in response to receiving a second selected PTV, transmitting a CID fare to the second PTV.

4. The method of claim 1, further comprising:
determining if the PTV has arrived at the destination;
in response to determining that the PTV has arrived at the destination, transmitting a feedback request to the MTD; and
in response to receiving a response to the feedback request, updating historical feedback data of a database entry of the selected PTV with the feedback data.

5. The method of claim 4, further comprising, in response to not receiving the response to the feedback request within a pre-established amount of time, transmitting a secondary feedback request to a secondary contact registered to the owner of the MTD.

6. The method of claim 1, further comprising:
receiving a fare cost from the selected PTV, wherein the fare cost is the total cost billed to the user of the MTD; and
in response to receiving the fare cost, updating historical fare cost data of the database entry of the selected PTV with the fare cost.

7. The method of claim 1, further comprising:
determining one or more public transportation vehicles (PTVs) within proximate range of the starting location; and
creating the PTV selection list, wherein the PTV selection list specifies one or more PTVs within proximate range of the starting location.

8. The method of claim 7, further comprising:
attaching historical data of one or more of the specified PTVs of the PTV selection list, wherein the historical data contains one or more of:
historical fare information of the PTV, and
historical feedback data of the PTV.

9. A computer comprising:
a processor;
a transceiver;
a memory coupled to the processor;
processing logic for:
receiving a transportation request from a mobile telecommunication device (MTD), wherein the transportation request includes a starting location and a destination;
transmitting a public transportation vehicle (PTV)selection list to the MTD;
in response to receiving a PTV selection from the MTD, transmitting a customer identification (CID) fare to the selected PTV, wherein the CID fare contains the starting location and the destination location of a desired transportation request; and
receiving a fare confirmation from the selected PTV, wherein the fare confirmation confirms that an operator of the selected PTV has accepted the transportation request and is en-route to the starting location.

10. The computer of claim 9, the processing logic further comprising logic for, in response to receiving the fare confirmation within a pre-established amount of time, transmitting a notification message to the MTD, wherein the notification message informs the user of the MTD that the selected PTV has confirmed the CID fare and is en-route to the starting location.

11. The computer of claim 9, the processing logic further comprising logic for:
in response to not receiving the fare confirmation within the pre-established amount of time, establishing a phone call connection between the MTD and a dispatcher;
transmitting an instruction to the MTD to select a second PTV; and
in response to receiving a second selected PTV, transmitting a CID fare to the second PTV.

12. The computer of claim 9, the processing logic further comprising logic for: determining if the PTV has arrived at the destination;
in response to determining that the PTV has arrived at the destination, transmitting a feedback request to the MTD; and in response to receiving a response to the feedback request, updating historical feedback data of a database entry of the selected PTV with the feedback data.

13. The computer of claim 12, the processing logic further comprising logic for, in response to not receiving the response to the feedback request within a pre-established amount of time, transmitting a secondary feedback request to a secondary contact registered to the owner of the MTD.

14. The computer of claim 9, the processing logic further comprising logic for:
receiving a fare cost from the selected PTV, wherein the fare cost is the total cost billed to the user of the MTD; and
in response to receiving the fare cost, updating historical fare cost data of the database entry of the selected PTV with the fare cost.

15. The computer of claim 9, the processing logic further comprising logic for:
determining one or more public transportation vehicles (PTVs) within proximate range of the starting location; and
creating the PTV selection list, wherein the PTV selection list specifies one or more PTVs within proximate range of the starting location.

16. The computer of claim 15, the processing logic further comprising logic for:
attaching historical data of one or more of the specified PTVs of the PTV selection list, wherein the historical data contains one or more of:
historical fare information of the PTV, and
historical feedback data of the PTV.

17. A computer-readable medium having a plurality of instructions embodied therein, wherein the plurality of instructions, when executed by a processing device, allows a machine to:
receive a transportation request from a mobile telecommunication device (MTD), wherein the transportation request includes a starting location and a destination;
transmit a public transportation vehicle (PTV) selection list to the MTD;
in response to receiving a PTV selection from the MTD, transmit a customer identification (CID) fare to the selected PTV, wherein the CID fare contains the starting location and the destination location of a desired transportation request;
receive a fare confirmation from the selected PTV, wherein the fare confirmation confirms that an operator of the selected PTV has accepted the transportation request and is en-route to the starting location;
in response to receiving the fare confirmation within a pre-established amount of time, transmit a notification message to the MTD, wherein the notification message informs the user of the MTD that the selected PTV has confirmed the CID fare and is en-route to the starting location;
receive a fare cost from the selected PTV, wherein the fare cost is the total cost billed to the user of the MTD; and
in response to receiving the fare cost, update historical fare cost data of the database entry of the selected PTV with the fare cost.

18. The computer-readable medium of claim 17, the plurality of instructions further comprising instructions for enabling the machine to:
in response to not receiving the fare confirmation within the pre-established amount of time, establish a phone call connection between the MTD and a dispatcher;
transmit an instruction to the MTD to select a second PTV; and
in response to receiving a second selected PTV, transmit a CID fare to the second PTV.

19. The computer-readable medium of claim 17, the plurality of instructions further comprising instructions for enabling the machine to:
determine if the PTV has arrived at the destination;
in response to determining that the PTV has arrived at the destination, transmit a feedback request to the MTD;
in response to receiving a response to the feedback request, update historical feedback data of a database entry of the selected PTV with the feedback data; and
in response to not receiving the response to the feedback request within a pre-established amount of time, transmit a secondary feedback request to a secondary contact registered to the owner of the MTD.

20. The computer-readable medium of claim 17, the plurality of instructions further comprising instructions for enabling the machine to:
determine one or more public transportation vehicles (PTVs) within proximate range of the starting location; and
create the PTV selection list, wherein the PTV selection list specifies one or more PTVs within proximate range of the starting location.
attach historical data of one or more of the specified PTVs of the PTV selection list, wherein the historical data contains one or more of:
historical fare information of the PTV, and
historical feedback data of the PTV.
